(19) United States
(12) Patent Application Publication
(10) Pub. No.: US 2025/0053167 A1
(43) Pub. Date: Feb. 13, 2025

(54) BACKUP SYSTEM FOR OBSERVABILITY, COMMUNICATION, AND CONTROL OF AUTONOMOUS SYSTEMS

(71) Applicant: GM CRUISE HOLDINGS LLC, SAN FRANCISCO, CA (US)

(72) Inventors: Jacob Rosenberg, San Francisco, CA (US); Matthew John Sokolowsky, Seattle, WA (US); Mariana Borba, Chicago, IL (US); Pushun Sheth, San Jose, CA (US); Chung Ho, Seattle, WA (US); Roman Porter, Bellevue, WA (US); Jeanie Zhiling Zheng, Bellevue, WA (US)

(73) Assignee: GM CRUISE HOLDINGS LLC, SAN FRANCISCO, CA (US)

(21) Appl. No.: 18/448,706

(22) Filed: Aug. 11, 2023

(51) Int. Cl. G05D 1/00; G05D 1/02; G08G 1/00; H04L 9/40

(52) U.S. Cl. CPC G05D 1/0027; G08G 1/20; H04L 63/0807

(57) ABSTRACT

Disclosed are embodiments for facilitating a backup system for observability, communication, and control of autonomous systems. In some aspects, an embodiment includes initializing an instance of a backup tool to provide observability, communication, and control of a fleet of autonomous vehicles (AVs) responsive to an outage of primary fleet tool services; storing AV data received from the fleet of AVs in in-memory storage of the instance of the backup tool; populating a cache of the backup tool with semi-static data corresponding to the fleet of AVs; authenticating a user requesting access to the instance, the authenticating to utilize credentials of the user established with the primary fleet tool services; and facilitating the issuance of one or more control commands to the fleet of AVs based on the AV data stored in the in-memory storage and based on the semi-static data stored in the cache.

### BACKGROUND

### 1. Technical Field

The disclosure generally relates to the field of processing systems and, more specifically, to a backup system for observability, communication, and control of autonomous systems.

### 2. Introduction

Autonomous vehicles, also known as self-driving cars, driverless vehicles, and robotic vehicles, may be vehicles that use multiple sensors to sense the environment and move without a human driver. An example autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system.

### BRIEF DESCRIPTION OF THE DRAWINGS

The various advantages and features of the disclosed technology will become apparent by reference to specific embodiments illustrated in the appended drawings. A person of ordinary skill in the art will understand that these drawings show some examples of the disclosed technology and would not limit the scope of the disclosed technology to these examples. Furthermore, the skilled artisan will appreciate the principles of the disclosed technology as described and explained with additional specificity and detail through the use of the accompanying drawings in which:

FIG. 1 is a block diagram of an example system illustrating a backup system for observability, communication, and control of autonomous systems, in accordance with embodiments herein;

FIG. 2 is a block diagram of a detailed view of an example autonomous environment implementing a backup tool providing a control plane for an autonomous vehicle (AV), in accordance with embodiments herein;

FIG. 3 illustrates an example method implementing a backup system for observability, communication, and control of autonomous systems, in accordance with embodiments herein;

FIG. 4 illustrates an example method implementing an authorization and authentication protocol for a backup system for observability, communication, and control of autonomous systems, in accordance with embodiments herein;

FIG. 5 illustrates an example method for implementing data population for a backup system for observability, communication, and control of autonomous systems, in accordance with embodiments herein;

FIG. 6 illustrates an example method for implementing a command issuance for a backup system for observability, communication, and control of autonomous systems, in accordance with embodiments herein;

FIG. 7 illustrates an example system environment that can be used to facilitate AV dispatch and operations, according to some aspects of the disclosed technology; and

FIG. 8 illustrates an example processor-based system with which some aspects of the subject technology can be implemented.

### DETAILED DESCRIPTION

The detailed description set forth below is intended as a description of various configurations of the subject technology and is not intended to represent the configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Autonomous vehicles (AVs), also known as self-driving cars, driverless vehicles, and robotic vehicles, can be implemented by companies to provide self-driving car services for the public, such as taxi or ride-hailing (e.g., ridesharing) services. The AV can navigate about roadways without a human driver based upon sensor signals output by sensor systems deployed on the AV. AVs may utilize multiple sensors to sense the environment and move without a human driver. An example AV can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system.

Operation of a fleet of AVs utilizes fleet services that operate to control and/or observe the fleet of AVs. These fleet services may also be referred to herein as an observability and control plane. In some embodiments, these fleet services are provided in a cloud computing architecture and can be referred to as fleet cloud services. The fleet services (or fleet cloud services) may include vehicle services, vehicle communications (e.g., communication gateway), dispatch, fleet operations, and others. During operation of the fleet of AVs, the loss or malfunction of the fleet services used to control or observe the fleet can cause fleet-wide pullovers. The fleetwide pullovers involve stopping maneuvers for each of the AVs. For each stopping maneuver executed by an AV, some risk exists that the AV cannot successfully pull over and may instead stop in its lane. This can potentially result in an increased risk of severe or catastrophic events with respect to the fleet of AVs. These events can include disruption to other drivers, disruption to emergency vehicles (e.g., ambulance, fire, police, etc.), and/or disruption to mass transit.

In order to reduce the risk of the severe or catastrophic events occurring during an outage (e.g., a loss or malfunction) of the primary fleet services, embodiments herein provide a backup system for observability, communication, and control of autonomous systems. The backup system may be a high-availability backup tool that provides degraded versions of a set of workflows to enable continued safe operation of the fleet of AVs during an outage of the primary fleet services. This backup system can prevent such outages from causing the above-noted severe or catastrophic events.

The high-availability backup tool of embodiments herein provides users, such as operators and technical operation specialists, with backup tooling to allow a fleet of AVs to run safely in perpetuity or to be summoned to safe locations (e.g., a selected facility) while availability of the primary fleet services is restored. In embodiments herein, the high-availability backup tool includes reduced dependencies and allows for high availability by implementing a bootstrapping authentication and authorization protocol, providing an always-on operation mode that collects fleet data in advance, and providing a condensed tool set of commands that can be issued directly to the fleet of AVs to enable continued operational function of the fleet of AVs.

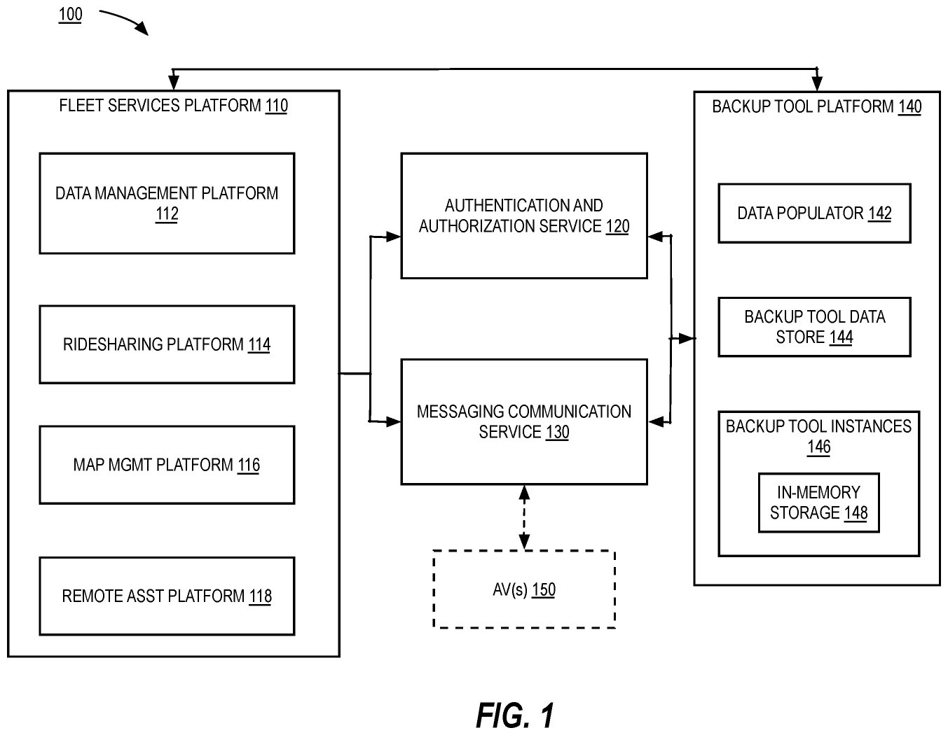

Although some embodiments herein are described as operating in an AV, other embodiments may be implemented in an environment that is not an AV, such as, for example, other types of vehicles (human operated, driver-assisted vehicles, etc.), air and terrestrial traffic control, radar astronomy, air-defense systems, anti-missile systems, marine radars to locate landmarks and other ships, aircraft anti-collision systems, ocean surveillance systems, outer space surveillance and rendezvous systems, meteorological precipitation monitoring, altimetry and flight control systems, guided missile target locating systems, ground-penetrating radar for geological observations, and so on. Furthermore, other embodiments may be more generally implemented in any artificial intelligence and/or machine learning-type environment. The following description discussed embodiments as implemented in an automotive environment, but one skilled in the art will appreciate that embodiments may be implemented in a variety of different environments and use cases. Further details of the backup system for observability, communication, and control of autonomous systems of embodiments herein are further described below with respect to FIGS. 1-8.

FIG. 1 is a block diagram of an example system 100 illustrating a backup system for observability, communication, and control of autonomous systems, in accordance with embodiments herein. In one embodiment, system 100 implements a backup tool platform for providing observability, communication, and control of autonomous systems, such as AV systems, as described further herein. The system 100 of FIG. 1 can be, for example, part of a data center that is cloud-based or otherwise. In other examples, the system 100 can be part of an AV or a human-operated vehicle having an advanced driver assistance system (ADAS) that can utilize various sensors including radar sensors.

In one embodiment, system 100 can communicate over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.). In one embodiment, system 100 can be implemented using a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth.

The system 100 may be part of a data center for managing a fleet of AVs and AV-related services. The data center can send and receive various signals to and from an AV. These signals can include sensor data captured by the sensor systems of the AV, roadside assistance requests, software updates, ridesharing pick-up and drop-off instructions, and so forth. In some examples, the system 100 may be hosted in a data center that may also support a ridesharing service, a delivery service, a remote/roadside assistance service, street services (e.g., street mapping, street patrol, street cleaning, street metering, parking reservation, etc.), and the like. In some embodiments, the system 100 may be implemented in the AV itself or may be implemented in a server computing device.

In this example, the system 100 includes one or more of a fleet services platform 110, an authentication and authorization service 120, a messaging communication service 130, and a backup tool platform 140, among other systems.

Fleet services platform 110 can provide an infrastructure for the various backend services used to control and observe one or more fleets of AVs. The fleet services platform 110 may provide for vehicle services, vehicle communications (e.g., communication gateway), dispatch, fleet operations, and others. In some embodiments, the fleet services platform 110 can be implemented as a variety of different cloud services and can be referred to as fleet cloud services. The fleet services platform 110 may further include a data management platform 112, a ridesharing platform 114, a map management platform 116, and a remote assistance platform 118.

The data management platform 112 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics.

The ridesharing platform 114 can interact with a customer of a ridesharing service via a ridesharing application executing on a client computing device. The client computing device can be a customer's mobile computing device or a computing device integrated with the AV. The ridesharing platform 114 can receive requests to be picked up or dropped off from the ridesharing application and dispatch the AV for the trip.

The map management platform 116 can provide a set of tools for the manipulation and management of geographic and spatial (geospatial) and related attribute data. The map management platform 116 can receive LIDAR point cloud data, image data (e.g., still image, video, etc.), RADAR data, GPS data, and other sensor data (e.g., raw data) from one or more AVs 702, Unmanned Aerial Vehicles (UAVs), satellites, third-party mapping services, and other sources of geospatially referenced data. The raw data can be processed, and map management platform 116 can render base representations (e.g., tiles (2D), bounding volumes (3D), etc.) of the AV geospatial data to enable users to view, query, label, edit, and otherwise interact with the data. Map management platform 116 can manage workflows and tasks for operating on the AV geospatial data.

The remote assistance platform 118 can generate and transmit instructions regarding the operation of the AV. For example, the remote assistance platform 118 can prepare instructions for one or more stacks or other components of the AV.

The authentication and authorization service 120 can enable authentication and authorization of users of the fleet services platform 110. In one embodiment, the authentication and authorization service 120 is an identity and access management provider for the fleet services platform 110. For example, the authentication and authorization service 120 may provide a single sign-on service that allows users to log into a variety of systems using one centralized process. The authentication and authorization service 120 may issue one or more unique access tokens to a user upon authentication and/or authorization by authentication and authorization service 120. An access token may refer to a small piece of data that provides permission for access. In some embodiments, the access token can be a temporary opaque identifier used to look up permissions in the service being access or it may be a cryptographically-signed piece of data including the information to be accessed that is valid for a set period of time. For example, information about the user, permissions, groups, and timeframes can be embedded within one token that passes from the authentication and authorization service 120 to the user's device.

The messaging communication service 130 can enable a communication gateway between the fleet services platform 110 and one or more AVs 150 (of a fleet of AVs). The messaging communication service 130 may also act as a communication gateway between one or more other cloud services within system 100.

Using the platforms 112-118 hosted by fleet services platform 110, an observability and control plane for one or more fleets of AVs can be provided by system 100. However, during operation of the fleet of AVs, the loss or malfunction of the fleet services platform 110 used to control or observe the fleet can cause fleet-wide pullovers. The fleetwide pullovers involves stopping maneuvers for each of the AVs. For each stopping maneuver executed by an AV, some risk exists that the AV cannot successfully pull over and may instead stop in its lane. This can potentially result in an increased risk of severe or catastrophic events with respect to the fleet of AVs. These events can include disruption to other drivers, disruption to emergency vehicles, and/or disruption to mass transit.

In order to reduce the risk of the severe or catastrophic events occurring during an outage (e.g., a loss or malfunction) of the primary fleet services, embodiments herein provide a backup system for observability, communication, and control of autonomous systems, such as AVs 150. The backup system may be provided as backup tool platform 140 in system 100. The backup tool platform 140 can implement a high-availability backup tool that provides degraded versions of a set of workflows to enable continued safe operation of the fleet of AVs 150 during an outage of the fleet services platform 110. This backup tool platform 140 can prevent such outages from causing the above-noted severe or catastrophic events. Degraded versions of the set of workflows may refer to a subset of functionalities of primary workflows that enable continued safe operation of the fleet of AVs. The primary workflows provide a full suite of observability and control functionality for the fleet of AVs by providing AV location and status and a full set of commands to direct the AV to various locations. In one example, the degraded versions of the set of workflows could include the ability to determine AV location, determine AV status, command the AV to navigate in a circle in their current geographic area, command the AV to return to a specified location (such as a fleet facility), command the AV to cancel a command, or command the AV to stop.

The backup tool platform 140 of embodiments herein provides users, such as operators and technical operation specialists, with backup tooling to allow a fleet of AVs to run safely in perpetuity or to be summoned to safe locations (e.g., a selected facility) while availability of the primary fleet services is restored. In embodiments herein, the high-availability backup tool includes reduced dependencies and allows for high availability by implementing a bootstrapping authentication and authorization protocol, providing an always-on operation mode that collects fleet data in advance for use in observability and control functions, and providing a condensed tool set of commands that can be issued directly to the fleet of AVs to enable continued operational function of the fleet of AVs.

In one embodiment, the backup tool platform 140 may include a data populator 142, a backup tool data store 144, and one or more backup tool instances 146. More or less components than described herein may be included in backup tool platform 140. In one implementation, the backup tool platform 140 can deploy one or more backup tool instances 146 in clusters across multiple regions. The clusters can provide high-availability and failover resiliency. The regions may refer to the different datacenter locations. Deployment across multiple regions ensures resiliency in the event of a region-wide failure of fleet services.

In one embodiment, the backup tool instances 146 can each be provided as a single-page application (SPA) that a user can interact with. An SPA may refer to a web application or website that interacts with the user by dynamically rewriting the current web page with new data from the web server (instead of a method of a web browser loading entire new pages).

In embodiments herein, upon occurrence of an outage of the primary fleet services, a user may seek to access one of the backup tool instance 146. Embodiments herein provide for automatic authorization and authentication of the user with the backup tool instance 146. In one embodiment, existing access tokens for the primary fleet services platform 110 may be leveraged for the backup tool platform 140 (and backup tool instances 146).

In embodiments herein, the backup tool platform 140 and the backup tool instances 146 can be deployed as a subdomain of the fleet services platform 110. As the backup tool platform 140 is deployed as a subdomain of the fleet services platform 110, the access tokens issues for the fleet services platform 110 by the authentication and authorization service 120 can be utilized with the backup tool platform 140 for authentication and authorization purposes. This enables users that are actively working in the fleet services platform 110 before an outage to have valid access tokens for the backup tool platform 140. In some embodiments, the primary fleet services platform 110 may issue the access tokens that are used for authentication and authorization to the backup tool instances 146, but the access tokens issued to the backup tool instances 146 may not be valid for access to the primary fleet services platform 110 (e.g., a distinct access token would be provided for access to the primary fleet services platform 110).

Furthermore, in implementations herein, the authentication and authorization service 120 can proactively freshen access tokens when the access tokens have less than a determined threshold time to live (TTL) remaining. In one example, if the access token is set with a TTL of 24 hours, the authentication and authorization service 120 can utilize session expiration and re-login APIs to proactively update the access tokens when they have less than 12 hours of TTL remaining.

In some embodiments, an additional backup authentication and authorization service can be deployed for users to provide authentication and authorization services when the primary authentication and authorization service 120 is not available (e.g., experiencing an outage, etc.). In some embodiments, the backup authentication and authorization service may be deployed for a limited subset of users that should be granted access to the backup tool platform 140.

In some embodiments, the backup tool platform 140 may provide for real-time synchronization of AV fleet data that can be utilized by the backup tool platform 140 in the case of loss of access to primary fleet services platform 110 tools. The backup tool platform 140 can provide an always-on operation mode that collects fleet data in advance for use in observability and control functions. The backup tool platform 140 can include a data populator 142 that obtains AV data and AV fleet data used to support the observability and control functions provided by the backup tool platform 140 upon a fleet services outage.

With respect to AV data, the data populator 142 may listen to updates published by the messaging communication service 130. In some embodiments, the data populator 142 may subscribe to a messaging publication service offered by the messaging communication service 130. The messaging communication service 130 may be in regular communication with AVs 150 as the AVs 150 send regular updates to the fleet services platform 110 via the messaging communication service 130. These updates from the AV may include AV data such as, but not limited to, AV VIN, AV geolocation, AV mode (driverless, manual), AV charge level, AV hard disk capacity, AV cabin occupancy, AV degraded state, AV connectivity state, and so on. This AV data obtained from the messaging communication service may be stored in in-memory storage 148 of the backup tool instances 146. When new AV data is received, the stored values for the AV in in-memory storage 148 may be replaced with the new updated data.

In some embodiments, the data populator 142 may operate out-of-band to query the fleet services platform 110 for fleet data that is not specific to an operating AV. Such fleet data may include, but is not limited to, market geolocation area, facility location(s), facility capacity, AV name mappings to VINs, and so on. The data populator 142 may store this fleet data in a cache of the backup tool data store 144.

In some embodiments, multiple instances of the data populator 142 may be deployed to provide for resiliency in the backup tool platform 140. If multiple instances of the data populator 142 are deployed, then leader election techniques may be implemented to elect a leader data populator 142 to query the fleet services platform 110 for fleet data to populate in the backup tool data store 144 cache. The spares will be actively attempting to acquire the lock and the leader election utilizes the leader to heartbeat its lock. If the leader fails to heartbeat its lock within the predetermined time frame, a spare will take over and become the new leader. Once the leader sees that it no longer has the lock, it reverts to the spare behavior.

When the backup tool instance 146 receives observability (or visibility) requests for an AV from a user, the backup tool instance 146 can utilize the values stored in the in-memory storage 148 and/or the cache of the backup tool data store 144 to respond to the requests. If the values stored in the in-memory storage 148 for an AV are determined to be stale (e.g., received more than a determined time interval), then the backup tool instance 146 can attempt to query the messaging communication service 130 for the AV data directly. If the messaging communication service 130 is not responsive, then the backup tool instance 146 utilizes the most recently received AV data for the AV. If the values stored in the cache of the backup tool data store 144 are ‘stale’, the backup tool instance 146 can attempt to query the fleet services platform 110 for the fleet data. If the fleet services platform 110 is not responsive, then the backup tool instance 146 can utilize the most recently received fleet data to respond to requests.

In some embodiments, the data populator 142 can provide a UI to enable direct user input of values corresponding to the AV data and/or the fleet data into the backup tool platform 140. The direct user input via the UI allows for data entry from physical sources such as hard coded lists, paper copies, periodically generated reports, and so on.

In embodiments herein, responsive to an outage of the fleet services platform 110 (or at least a portion of the fleet services platform 110), a user can access a backup tool instance 146 of the backup tool platform 140 to obtain fallback observability and control of a fleet of AVs. As previously discussed, authorization and authentication with the backup tool instance 146 is provided via the validated access token for the user from the fleet services platform 110 via the authentication and authorization service 120.

During the outage of the fleet services platform 110, the backup tool instance 146 can provide a condensed tool set of commands that can be issued directly to the fleet of AVs to enable continued operational function of the fleet of AVs. Observability (e.g., operating AVs, location of AVs, operational status of AVs, etc.) of the fleet of AVs can be provided from the AV data and fleet data populated into the in-memory storage 148 and backup tool data store 144 during the always-on operation of the backup tool instance 146, as described above. Fallback options can include directly query the messaging communication service 130 and/or the fleet services platform 110. Serving this AV and fleet data from the backup tool platform data stores reduces the amount of load that the backup tool platform 140 puts on the messaging communication service 130.

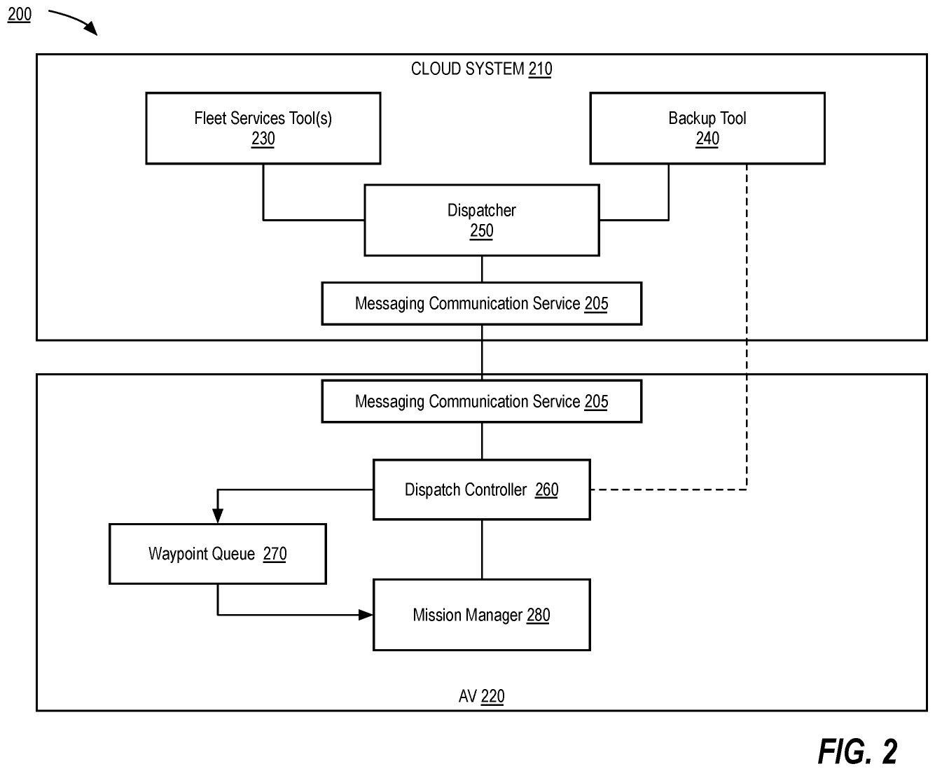

The backup tool platform 140 can also enable the backup tool instance 146 to provide control of the fleet of AVs during the outage of the fleet services platform 110. Further details of the control plane aspects of the backup tool platform 140 are described below with respect to FIG. 2.

FIG. 2 is a block diagram of a detailed view of an example autonomous environment 200 implementing a backup tool providing a control plane for an AV, in accordance with embodiments herein. In one embodiment, autonomous environment 200 may include a cloud system 210, which may be the same as system 100 of FIG. 1, and an AV 220, which may be the same as AV 150 described with respect to FIG. 1. More or less components than those depicted in autonomous environment 200

Cloud system 210 may include fleet services tools 230, backup tool 240, and dispatcher 250. In one embodiment, fleet services tools 230 may be the same as fleet services platform 110 described with respect to FIG. 1 and backup tool 240 may be the same as backup tool platform 140 described with respect to FIG. 1. Dispatcher 250 may be a server component that determines and manages waypoint locations to which an AV is dispatched to. Dispatcher 250 may communicate with a dispatch controller 260 on AV 220. Dispatch controller 260 may maintain a waypoint queue 270 to store the waypoints that are dispatched to the AV 220 by the dispatcher 250. In one embodiment, dispatcher 250 of cloud system 210 may communicate with (e.g., over a network) dispatch controller 260 of AV 220 via messaging communication service 205. Mission manager 280 of AV 220 may utilize the waypoint queue 270 to cause the AV 220 to navigate to one or more locations.

In one embodiment, the backup tool 240 can communicate with the dispatch controller 260 of AV 220 to issue commands to the AV 220. The commands provided via the backup tool 240 may be a reduced set of commands as compared to the commands enabled by the fleet services tools 230. The commands can include, but are not limited to, command to indicate whether the roads are wet, a stopping maneuver command, and dispatch commands including a summon command, a circle command, and a release command, for example. A summon command refers to a command to cause the AV to return to an arbitrary location, such as the fleet facility. A circle command refers to a command to cause the AV to run safely in perpetuity until a new command is received. A release command refers to a command to cause the AV to be released from control by the backup tool 240 and that dispatcher 250 should begin managing the waypoint queue 270 for the AV 220.

These commands can cause the dispatch controller 260 to stop accepting new assignments, complete their existing assignments, and then either generate random waypoints (e.g., circle) or return to the facility at the specified location (e.g., summon). Status updates will be reflected in the UI of the backup tool 240. Canceling a summon command can cause the AV to return to the circle mode behavior until fleet services tools 230 control (e.g., dispatcher 250 control) is restored.

In one embodiment, the backup tool 240 can take over the responsibility of providing backup heartbeats to prevent fleet auto-grounding from the lack of cloud connectivity. The backup tool 240 can provide the same heartbeat to the messaging communication service 205 (to prevent the fleet from auto-grounding) as well as a tool to execute individual and market-wide AV groundings.

With respect to the dispatch commands provided by the backup tool 240 during a fleet services tools 230 outage, one example approach to managing changes to the AV's 220 waypoint queue 270 by the backup tool 240 is to directly interact with the waypoint queue 270 on individual AVs 220. In this example, the dispatcher 250 may stop managing the waypoints on an AV 220 if the dispatcher 250 identifies a different set of waypoints in the AV's 220 waypoint queue 270 than was expected (dispatcher 250 keeps a record of the waypoint queue 270 in the cloud). In this case the dispatcher 250 can infer that the backup tool 240 has taken control over the waypoint queue 270.

In one embodiment, the backup tool 240 can signal to the dispatcher 250 that it is ready to relinquish control of the queue by setting a circle waypoint with a sentinel-value UUID. Because the AV 220 is circling until the dispatcher 250 provides a new waypoint, the AV 220 continues to drive in the interim. In one embodiment, the dispatcher 250 can provide the following workflows to detect and short-circuit if the waypoint queue 270 is different from what is expected by the cloud: (1) synchronize waypoints; (2) process reached destination; (3) optionally re-assign a ride; (4) reconcile waypoint queue; and (5) mark assignment location as active. In one embodiment, the return of control to the dispatcher 250 can be explicit. When in the control-handoff state, the same workflows can also check the UUID of the first waypoint in the queue to see if it is the sentinel-value UUID, indicating the backup tool 240 is returning control to the dispatcher 250.

In some embodiments, the dispatch commands of circle, summon, and release are the three waypoint-impacting commands. Each command is translated into a list of waypoints and executed. When executing the circle command, the backup tool 240 can pick a random latitude/longitude within a determined distance (e.g., 0.5 mi²) bounding box around the AV's 220 current location. The backup tool 240 can use this to construct a drive-past waypoint, which is sent as the sole waypoint in a replace waypoints call to the AV 220.

When executing the summon command, the backup tool 240 can use the provided latitude/longitude to construct a pullover waypoint for a determine location, which is sent as the sole waypoint in a ‘replace waypoints’ call. In some embodiments, the determined location can be a safe location, such as a selected fleet facility.

When executing the release command, the backup tool 240 can construct a waypoint that is a copy of the AV's 220 current waypoint from a dispatch state message but overwrites the waypoint's UUID with a sentinel value that specifies that the dispatcher 250 should begin managing the waypoint queue 270 for this AV 220 again. In one embodiment, the dispatcher 250 does not persist this waypoint to its database when consuming incoming dispatch state from the AV 220. Furthermore, even though this sentinel UUID does not uniquely identify a single waypoint, it should not cause any data integrity issues because the waypoint in question may be known to be a duplicate and thus is not persisted by the dispatcher 250.

In some embodiments, the backup tool 240 takes into consideration whether there are passengers in the AV 220 when issuing dispatch commands. For example, the AV data provided to the backup tool 240 may indicate the number of passengers in the AV 220. In one embodiment, in the case of passenger occupancy in the AV 220, the backup tool 240 may not alter waypoints until there is no reported occupancy. In the case of non-zero occupancy, the backup tool 240 can reject commands that alter the waypoint queue 270.

In one embodiment, when the backup tool 240 issues a circle command for an AV 220 (e.g., an AV 220 with zero occupancy), the backup tool 240 can generate a random latitude/longitude coordinate within a bounding box (e.g., square bounding box) and replace waypoints in the waypoint queue 270 with a drive-past waypoint at those coordinates. The drive-past waypoint enables the AV 220 to pass and continually re-route to the same waypoint until the waypoint queue 270 is again updated.

When the backup tool 240 issues a summon command for the AV 220 (e.g., with zero occupancy), the backup tool 240 can replace waypoints in the waypoint queue 270 with a list containing a single waypoint representing the summoning location (i.e., the selected facility).

In one embodiment, situations may be encountered where a race condition occurs in which the dispatcher 250 and the backup tool 240 both make calls to replace waypoints concurrently. In this case, if the dispatcher's 250 call is processed second it can overwrite the backup tool's 240 call. In such a case, the backup tool 240 can monitor the waypoint queue 270 of the AV 220 it is sending commands to and retry the replace waypoints call if the waypoint queue 270 does not update with the expected waypoint.

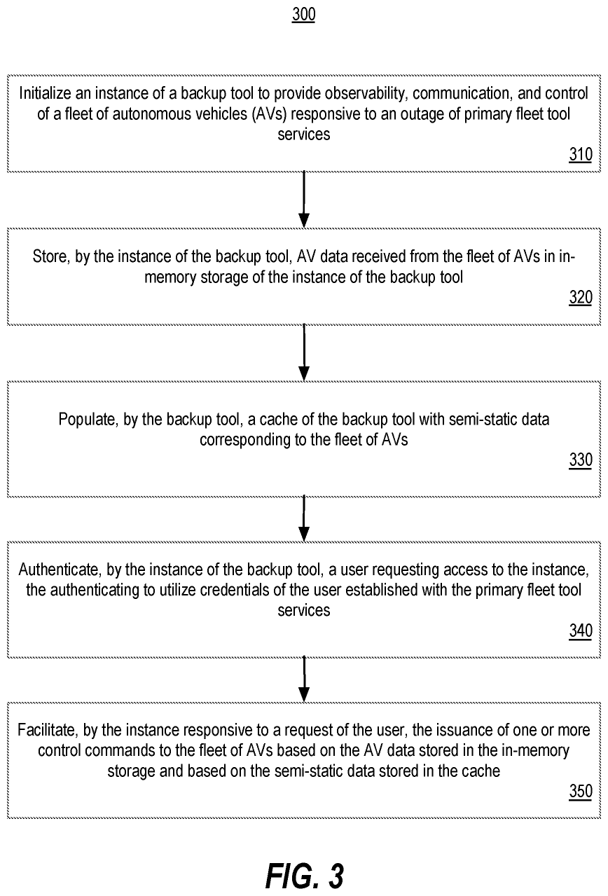

FIG. 3 illustrates an example method 300 implementing a backup system for observability, communication, and control of autonomous systems, in accordance with embodiments herein. Although the example method 300 depicts a particular sequence of operations, the sequence may be altered without departing from the scope of the disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some embodiments, the method 300 includes block 310 where an instance of a backup tool is initialized to provide observability and control of a fleet of AVs responsive to an outage of primary fleet tool services. Then, at block 320, the instance of the backup tool stores AV data received from the fleet of AVs in in-memory storage of the instance of the backup tool.

Subsequently, at block 330, the backup tool populates a cache of the backup tool with semi-static data corresponding to the fleet of AVs. At block 340, the instance of the backup tool authenticates and authorizes a user requesting access to the instance, the authenticating and authorizing to utilize credentials of the user established with the primary fleet tool services. Lastly, at block 350, the instance facilitates, responsive to a request of the user, the issuance of one or more control commands to the fleet of AVs based on the AV data stored in the in-memory storage and based on the semi-static data stored in the cache.

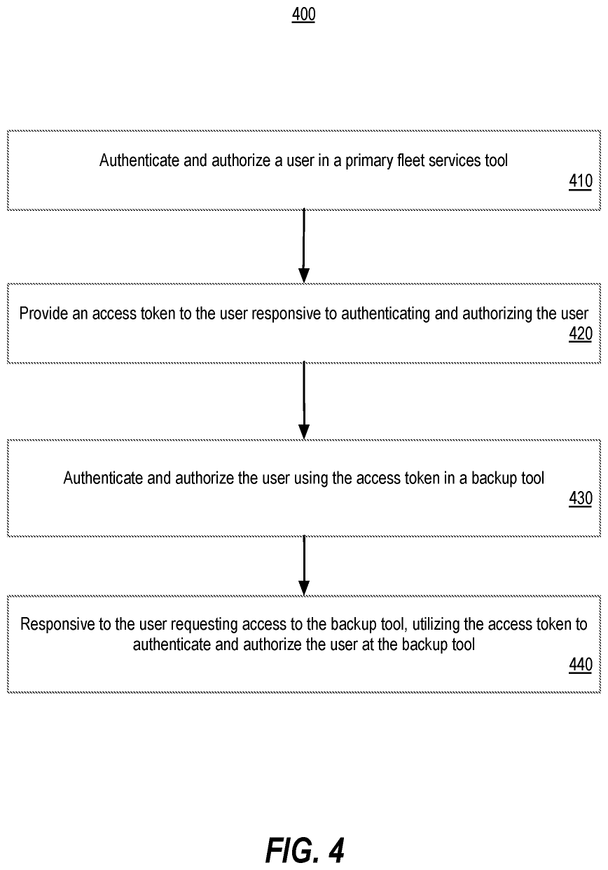

FIG. 4 illustrates an example method 400 implementing an authorization and authentication protocol for a backup system for observability, communication, and control of autonomous systems, in accordance with embodiments herein. Although the example method 400 depicts a particular sequence of operations, the sequence may be altered without departing from the scope of the disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some embodiments, the method 400 includes block 410 where a user in a primary fleet services tool is authenticated and authorized. In one embodiment, an authentication and authorization service, such as an identity provider, performs the authentication and authorization. At block 420, an access token is provided to the user responsive to authenticating and authorizing the user.

Subsequently, at block 430, the user is authenticated and authorized in a backup tool using the access token. In one embodiment, the backup tool is deployed as a subdomain of the primary fleet tool services to leverage (e.g., bootstrap) the access token used for authentication and authorization of the user with the primary fleet services tool with the backup tool as well. Lastly, at block 440, responsive to the user requesting access to the backup tool, the access token is utilized to authenticate and authorize the user at the backup tool.

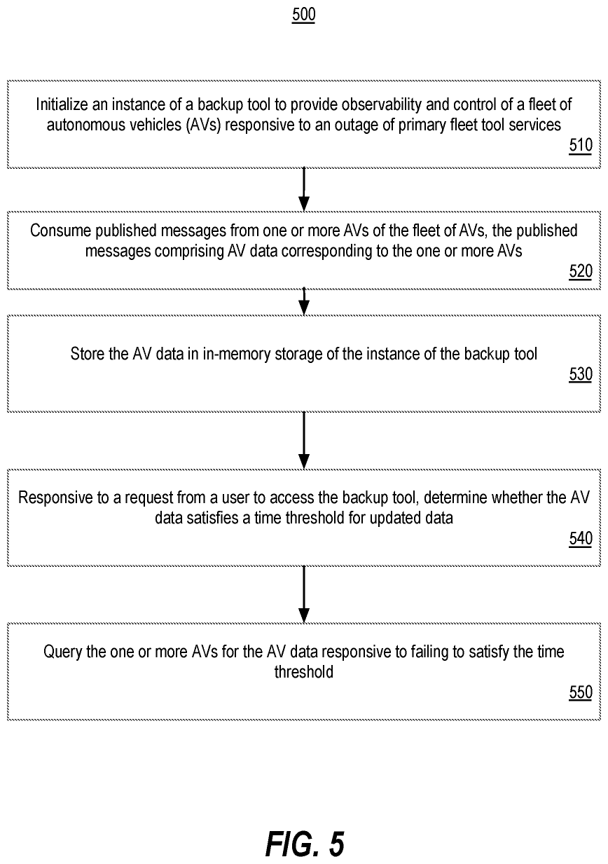

FIG. 5 illustrates an example method 500 for implementing data population for a backup system for observability, communication, and control of autonomous systems, in accordance with embodiments herein. Although the example method 500 depicts a particular sequence of operations, the sequence may be altered without departing from the scope of the disclosure. For example, some of the operations depicted may be performed in parallel or in a different sequence that does not materially affect the function of the method 500. In other examples, different components of an example device or system that implements the method 500 may perform functions at substantially the same time or in a specific sequence.

According to some embodiments, the method 500 includes block 510 where an instance of a backup tool is initialized to provide observability and control of a fleet of AVs responsive to an outage of primary fleet tool services. Then, at block 520, published messages from one or more AVs of the fleet of AVs are consumed by the backup tool. In one embodiment, the published messages include AV data corresponding to the one or more AVs.

Subsequently, at block 530, the AV data is stored in in-memory storage of the instance of the backup tool. At block 540, responsive to a request from a user to access the backup tool, the backup tool determines whether the AV data satisfies a time threshold for updated data. Lastly, at block 550, responsive to failing to satisfy the time threshold, the one or more AVs are queried for the AV data.

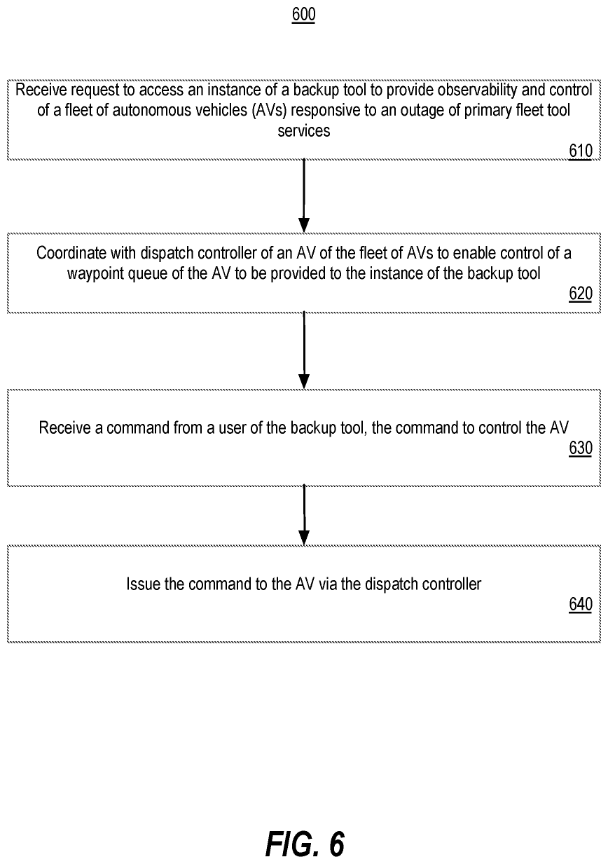

FIG. 6 illustrates an example method 600 for implementing a command issuance for a backup system for observability, communication, and control of autonomous systems, in accordance with embodiments herein. Although the example method 600 depicts a particular sequence of operations, the sequence may be altered without departing from the scope of the disclosure. For example, some of the operations depicted may be performed in parallel or in a different sequence that does not materially affect the function of the method 600. In other examples, different components of an example device or system that implements the method 600 may perform functions at substantially the same time or in a specific sequence.

According to some embodiments, the method 600 includes block 610 where request is received to access an instance of a backup tool to provide observability and control of a fleet of AVs responsive to an outage of primary fleet tool services. Then, at block 620, the backup tool coordinates with a dispatch controller of an AV of the fleet of AVs to enable control of a waypoint queue of the AV to be provided to the instance of the backup tool.

Subsequently, at block 630, a command is received from a user of the backup tool. In one embodiment, the command is to control the AV and may include one or more of a stopping maneuver command, a circle command, a summon command, or a release command. Lastly, at block 640, the command is issued to the AV via the dispatch controller.

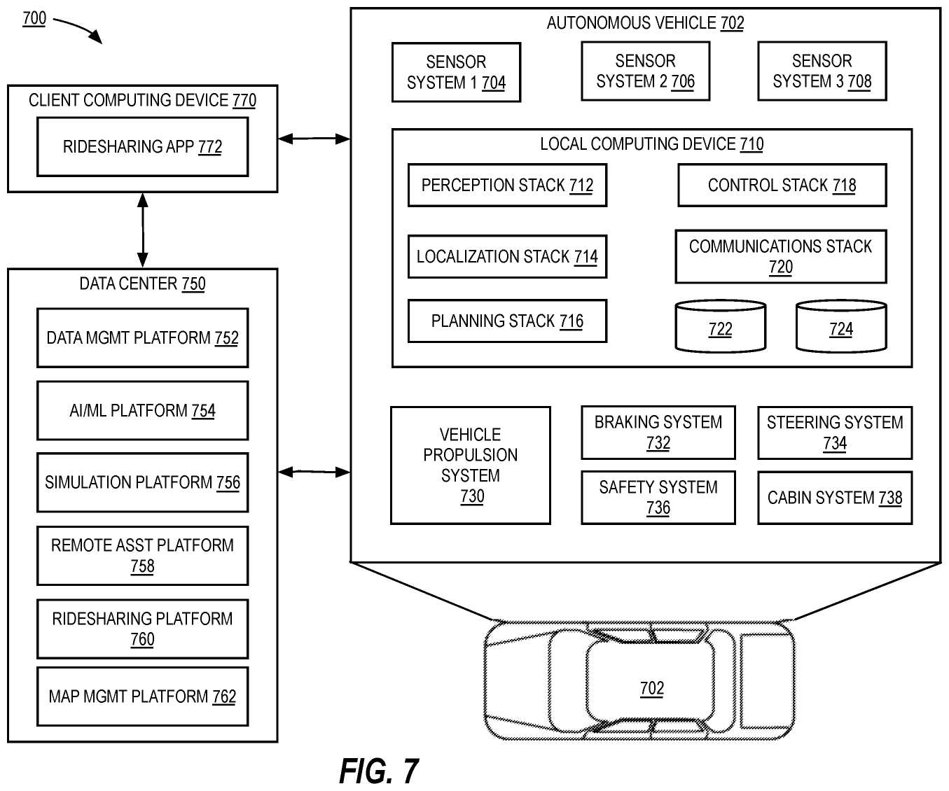

Turning now to FIG. 7, this figure illustrates an example of an AV management system 700. In one embodiment, the AV management system 700 can implement a backup system for observability, communication, and control of autonomous systems. One of ordinary skill in the art will understand that, for the AV management system 700 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 700 includes an AV 702, a data center 750, and a client computing device 770. The AV 702, the data center 750, and the client computing device 770 can communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 702 can navigate about roadways without a human driver based on sensor signals generated by multiple sensor systems 704, 706, and 708. The sensor systems 704-708 can include different types of sensors and can be arranged about the AV 702. For instance, the sensor systems 704-708 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 704 can be a camera system, the sensor system 706 can be a LIDAR system, and the sensor system 708 can be a RADAR system. Other embodiments may include any other number and type of sensors.

AV 702 can also include several mechanical systems that can be used to maneuver or operate AV 702. For instance, the mechanical systems can include vehicle propulsion system 730, braking system 732, steering system 734, safety system 736, and cabin system 738, among other systems. Vehicle propulsion system 730 can include an electric motor, an internal combustion engine, or both. The braking system 732 can include an engine brake, a wheel braking system (e.g., a disc braking system that utilizes brake pads), hydraulics, actuators, and/or any other suitable componentry configured to assist in decelerating AV 702. The steering system 734 can include suitable componentry configured to control the direction of movement of the AV 702 during navigation. Safety system 736 can include lights and signal indicators, a parking brake, airbags, and so forth. The cabin system 738 can include cabin temperature control systems, in-cabin entertainment systems, and so forth. In some embodiments, the AV 702 may not include human driver actuators (e.g., steering wheel, handbrake, foot brake pedal, foot accelerator pedal, turn signal lever, window wipers, etc.) for controlling the AV 702. Instead, the cabin system 738 can include one or more client interfaces (e.g., Graphical User Interfaces (GUIs), Voice User Interfaces (VUIs), etc.) for controlling certain aspects of the mechanical systems 730-738.

AV 702 can additionally include a local computing device 710 that is in communication with the sensor systems 704-708, the mechanical systems 730-738, the data center 750, and the client computing device 770, among other systems. The local computing device 710 can include one or more processors and memory, including instructions that can be executed by the one or more processors. The instructions can make up one or more software stacks or components responsible for controlling the AV 702; communicating with the data center 750, the client computing device 770, and other systems; receiving inputs from riders, passengers, and other entities within the AV's environment; logging metrics collected by the sensor systems 704-708; and so forth. In this example, the local computing device 710 includes a perception stack 712, a mapping and localization stack 714, a planning stack 716, a control stack 718, a communications stack 720, a High Definition (HD) geospatial database 722, and an AV operational database 724, among other stacks and systems.

Perception stack 712 can enable the AV 702 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 704-708, the mapping and localization stack 714, the HD geospatial database 722, other components of the AV, and other data sources (e.g., the data center 750, the client computing device 770, third-party data sources, etc.). The perception stack 712 can detect and classify objects and determine their current and predicted locations, speeds, directions, and the like. In addition, the perception stack 712 can determine the free space around the AV 702 (e.g., to maintain a safe distance from other objects, change lanes, park the AV, etc.). The perception stack 712 can also identify environmental uncertainties, such as where to look for moving objects, flag areas that may be obscured or blocked from view, and so forth.

Mapping and localization stack 714 can determine the AV's position and orientation (pose) using different methods from multiple systems (e.g., GPS, IMUs, cameras, LIDAR, RADAR, ultrasonic sensors, the HD geospatial database 722, etc.). For example, in some embodiments, the AV 702 can compare sensor data captured in real-time by the sensor systems 704-708 to data in the HD geospatial database 722 to determine its precise (e.g., accurate to the order of a few centimeters or less) position and orientation. The AV 702 can focus its search based on sensor data from one or more first sensor systems (e.g., GPS) by matching sensor data from one or more second sensor systems (e.g., LIDAR). If the mapping and localization information from one system is unavailable, the AV 702 can use mapping and localization information from a redundant system and/or from remote data sources.

The planning stack 716 can determine how to maneuver or operate the AV 702 safely and efficiently in its environment. For example, the planning stack 716 can receive the location, speed, and direction of the AV 702, geospatial data, data regarding objects sharing the road with the AV 702 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 702 from one point to another. The planning stack 716 can determine multiple sets of one or more mechanical operations that the AV 702 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 716 can select from multiple backup plans to carry out. For example, while preparing to change lanes to turn right at an intersection, another vehicle may aggressively cut into the destination lane, making the lane change unsafe. The planning stack 716 could have already determined an alternative plan for such an event, and upon its occurrence, help to direct the AV 702 to go around the block instead of blocking a current lane while waiting for an opening to change lanes.

The control stack 718 can manage the operation of the vehicle propulsion system 730, the braking system 732, the steering system 734, the safety system 736, and the cabin system 738. The control stack 718 can receive sensor signals from the sensor systems 704-708 as well as communicate with other stacks or components of the local computing device 710 or a remote system (e.g., the data center 750) to effectuate operation of the AV 702. For example, the control stack 718 can implement the final path or actions from the multiple paths or actions provided by the planning stack 716. This can involve turning the routes and decisions from the planning stack 716 into commands for the actuators that control the AV's steering, throttle, brake, and drive unit.

The communication stack 720 can transmit and receive signals between the various stacks and other components of the AV 702 and between the AV 702, the data center 750, the client computing device 770, and other remote systems. The communication stack 720 can enable the local computing device 710 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 720 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 722 can store HD maps and related data of the streets upon which the AV 702 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

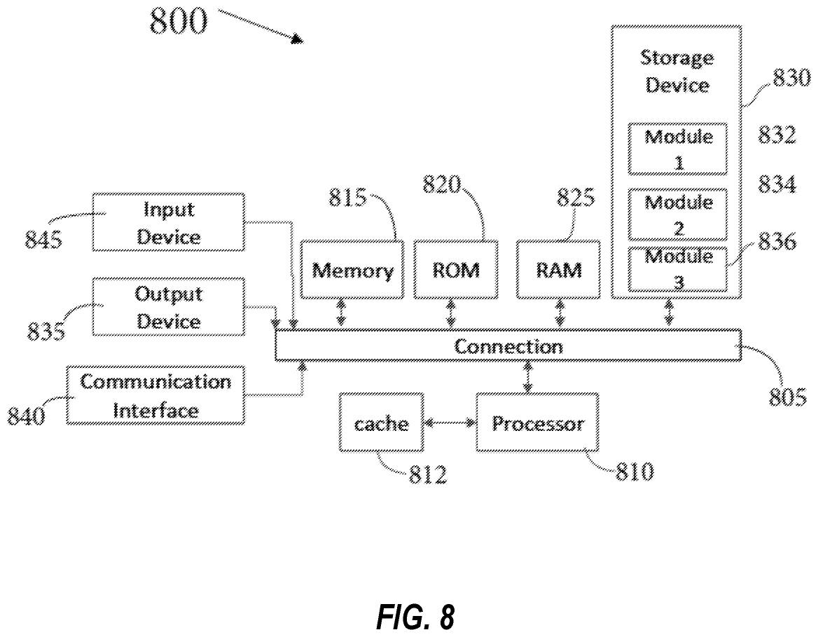

The AV operational database 724 can store raw AV data generated by the sensor systems 704-708 and other components of the AV 702 and/or data received by the AV 702 from remote systems (e.g., the data center 750, the client computing device 770, etc.). In some embodiments, the raw AV data can include HD LIDAR point cloud data, image or video data, RADAR data, GPS data, and other sensor data that the data center 750 can use for creating or updating AV geospatial data as discussed further below with respect to FIG. 8 and elsewhere in the present disclosure.

The data center 750 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 750 can include one or more computing devices remote to the local computing device 710 for managing a fleet of AVs and AV-related services. For example, in addition to managing the AV 702, the data center 750 may also support a ridesharing service, a delivery service, a remote/roadside assistance service, street services (e.g., street mapping, street patrol, street cleaning, street metering, parking reservation, etc.), and the like.

The data center 750 can send and receive various signals to and from the AV 702 and the client computing device 770. These signals can include sensor data captured by the sensor systems 704-708, roadside assistance requests, software updates, ridesharing pick-up and drop-off instructions, and so forth. In this example, the data center 750 includes one or more of a data management platform 752, an Artificial Intelligence/Machine Learning (AI/ML) platform 754, a simulation platform 756, a remote assistance platform 758, a ridesharing platform 760, and a map management platform 762, among other systems.

Data management platform 752 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 750 can access data stored by the data management platform 752 to provide their respective services.

The AI/ML platform 754 can provide the infrastructure for training and evaluating machine learning algorithms for operating the AV 702, the simulation platform 756, the remote assistance platform 758, the ridesharing platform 760, the map management platform 762, and other platforms and systems. Using the AI/ML platform 754, data scientists can prepare data sets from the data management platform 752; select, design, and train machine learning models; evaluate, refine, and deploy the models; maintain, monitor, and retrain the models; and so on.

The simulation platform 756 can enable testing and validation of the algorithms, machine learning models, neural networks, and other development efforts for the AV 702, the remote assistance platform 758, the ridesharing platform 760, the map management platform 762, and other platforms and systems. The simulation platform 756 can replicate a variety of driving environments and/or reproduce real-world scenarios from data captured by the AV 702, including rendering geospatial information and road infrastructure (e.g., streets, lanes, crosswalks, traffic lights, stop signs, etc.) obtained from the map management platform 762; modeling the behavior of other vehicles, bicycles, pedestrians, and other dynamic elements; simulating inclement weather conditions, different traffic scenarios; and so on.

The remote assistance platform 758 can generate and transmit instructions regarding the operation of the AV 702. For example, in response to an output of the AI/ML platform 754 or other system of the data center 750, the remote assistance platform 758 can prepare instructions for one or more stacks or other components of the AV 702.

The ridesharing platform 760 can interact with a customer of a ridesharing service via a ridesharing application 772 executing on the client computing device 770. The client computing device 770 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 772. The client computing device 770 can be a customer's mobile computing device or a computing device integrated with the AV 702 (e.g., the local computing device 710). The ridesharing platform 760 can receive requests to be picked up or dropped off from the ridesharing application 772 and dispatch the AV 702 for the trip.

Map management platform 762 can provide a set of tools for the manipulation and management of geographic and spatial (geospatial) and related attribute data. The data management platform 752 can receive LIDAR point cloud data, image data (e.g., still image, video, etc.), RADAR data, GPS data, and other sensor data (e.g., raw data) from one or more AVs 702, Unmanned Aerial Vehicles (UAVs), satellites, third-party mapping services, and other sources of geospatially referenced data. The raw data can be processed, and map management platform 762 can render base representations (e.g., tiles (2D), bounding volumes (3D), etc.) of the AV geospatial data to enable users to view, query, label, edit, and otherwise interact with the data. Map management platform 762 can manage workflows and tasks for operating on the AV geospatial data. Map management platform 762 can control access to the AV geospatial data, including granting or limiting access to the AV geospatial data based on user-based, role-based, group-based, task-based, and other attribute-based access control mechanisms. Map management platform 762 can provide version control for the AV geospatial data, such as to track specific changes that (human or machine) map editors have made to the data and to revert changes when necessary. Map management platform 762 can administer release management of the AV geospatial data, including distributing suitable iterations of the data to different users, computing devices, AVs, and other consumers of HD maps. Map management platform 762 can provide analytics regarding the AV geospatial data and related data, such as to generate insights relating to the throughput and quality of mapping tasks.

In some embodiments, the map viewing services of map management platform 762 can be modularized and deployed as part of one or more of the platforms and systems of the data center 750. For example, the AI/ML platform 754 may incorporate the map viewing services for visualizing the effectiveness of various object detection or object classification models, the simulation platform 756 may incorporate the map viewing services for recreating and visualizing certain driving scenarios, the remote assistance platform 758 may incorporate the map viewing services for replaying traffic incidents to facilitate and coordinate aid, the ridesharing platform 760 may incorporate the map viewing services into the client application 772 to enable passengers to view the AV 702 in transit en route to a pick-up or drop-off location, and so on.

FIG. 8 illustrates an example processor-based system with which some aspects of the subject technology can be implemented. For example, processor-based system 800 can be any computing device making up, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with hardware components, such as processor 810, connection 805, output device 835, etc., to carry out the function.

Embodiments within the scope of the disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Example 1 includes a method for facilitating a backup system for observability, communication, and control of autonomous systems, where the method comprises initializing, by a processing device, an instance of a backup tool to provide observability, communication, and control of a fleet of autonomous vehicles (AVs) responsive to an outage of primary fleet tool services; storing, by the instance of the backup tool, AV data received from the fleet of AVs in in-memory storage of the instance of the backup tool; populating, by the backup tool, a cache of the backup tool with semi-static data corresponding to the fleet of AVs; authenticating, by the instance of the backup tool, a user requesting access to the instance, the authenticating to utilize credentials of the user established with the primary fleet tool services; and facilitating, by the instance responsive to a request of the user, issuance of one or more control commands to the fleet of AVs based on the AV data stored in the in-memory storage and based on the semi-static data stored in the cache.

In Example 2, the subject matter of Example 1 can optionally include wherein the AV data is received via messages published by the AV and consumed by the backup tool on an intermittent basis. In Example 3, the subject matter of any one of Examples 1-2 can optionally include wherein the semi-static data comprises fleet data corresponding to the fleet of AVs, wherein the fleet data comprises one or more of a list of fleets in a market of the fleet of AVs, a list of fleet facilities in the market of the fleet of AVs, physical locations of the fleet facilities, or vehicle identification numbers (VINs) of AVs of each of the fleets in the market.

In Example 4, the subject matter of any one of Examples 1-3 can optionally include wherein responsive to the user being authenticated with the primary fleet tool services using an access token, authenticating the user with the backup tool using the access token. In Example 5, the subject matter of any one of Examples I-4 can optionally include wherein the authenticating further comprises authorizing the user, and wherein the backup tool is served as a subdomain of the primary fleet tool services to enable the authenticating and the authorizing the user with the backup tool using the access token. In Example 6, the subject matter of any one of Examples 1-5 can optionally include wherein the access token is proactively refreshed when a time to live (TTL) of the access token falls below a threshold value.

In Example 7, the subject matter of any one of Examples I-6 can optionally include wherein the one or more control commands comprise at least one of a stop command, a summon command, a circle command, and a release command. In Example 8, the subject matter of any one of Examples 1-7 can optionally include wherein causing the one or more control commands to be issued further comprises directly interfacing with a dispatch controller of at least one of the AVs. In Example 9, the subject matter of any one of Examples 1-8 can optionally include wherein a dispatcher is signaled to transition control of the fleet of AVs to the instance of the backup tool.

Example 10 includes an apparatus for facilitating a backup system for observability, communication, and control of autonomous systems, the apparatus of Example 10 comprising one or more hardware processors to: initialize an instance of a backup tool to provide observability, communication, and control of a fleet of autonomous vehicles (AVs) responsive to an outage of primary fleet tool services; store, by the instance of the backup tool, AV data received from the fleet of AVs in in-memory storage of the instance of the backup tool; populate, by the backup tool, a cache of the backup tool with semi-static data corresponding to the fleet of AVs; authenticate, by the instance of the backup tool, a user requesting access to the instance, the authenticating to utilize credentials of the user established with the primary fleet tool services; and facilitate, by the instance responsive to a request of the user, issuance of one or more control commands to the fleet of AVs based on the AV data stored in the in-memory storage and based on the semi-static data stored in the cache.

In Example 11, the subject matter of Example 10 can optionally include wherein the AV data is received via messages published by the AV and consumed by the backup tool on an intermittent basis. In Example 12, the subject matter of Examples 10-11 can optionally include wherein the semi-static data comprises fleet data corresponding to the fleet of AVs, wherein the fleet data comprises one or more of a list of fleets in a market of the fleet of AVs, a list of fleet facilities in the market of the fleet of AVs, physical locations of the fleet facilities, or vehicle identification numbers (VINs) of AVs of each of the fleets in the market.

In Example 13, the subject matter of Examples 10-12 can optionally include wherein responsive to the user being authenticated with the primary fleet tool services using an access token, authenticating the user with the backup tool using the access token, wherein the authenticating further comprises authorizing the user, and wherein the backup tool is served as a subdomain of the primary fleet tool services to enable the authenticating and the authorizing the user with the backup tool using the access token. In Example 14, the subject matter of Examples 10-13 can optionally include wherein the one or more control commands comprise at least one of a stop command, a summon command, a circle command, and a release command. In Example 15, the subject matter of Examples 10-14 can optionally include wherein causing the one or more control commands to be issued further comprises directly interfacing with a dispatch controller of at least one of the AVs, wherein a dispatcher is signaled to transition control of the fleet of AVs to the instance of the backup tool.

Example 16 is a non-transitory computer-readable storage medium for facilitating a backup system for observability, communication, and control of autonomous systems. The non-transitory computer-readable storage medium of Example 16 having stored thereon executable computer program instructions that, when executed by one or more processors, cause the one or more processors to: initialize an instance of a backup tool to provide observability, communication, and control of a fleet of autonomous vehicles (AVs) responsive to an outage of primary fleet tool services; store, by the instance of the backup tool, AV data received from the fleet of AVs in in-memory storage of the instance of the backup tool; populate, by the backup tool, a cache of the backup tool with semi-static data corresponding to the fleet of AVs; authenticate, by the instance of the backup tool, a user requesting access to the instance, the authenticating to utilize credentials of the user established with the primary fleet tool services; and facilitate, by the instance responsive to a request of the user, issuance of one or more control commands to the fleet of AVs based on the AV data stored in the in-memory storage and based on the semi-static data stored in the cache.

In Example 17, the subject matter of Example 16 can optionally include wherein the AV data is received via messages published by the AV and consumed by the backup tool on an intermittent basis. In Example 18, the subject matter of Examples 16-17 can optionally include wherein the semi-static data comprises fleet data corresponding to the fleet of AVs, wherein the fleet data comprises one or more of a list of fleets in a market of the fleet of AVs, a list of fleet facilities in the market of the fleet of AVs, physical locations of the fleet facilities, or vehicle identification numbers (VINs) of AVs of each of the fleets in the market.

In Example 19, the subject matter of Examples 16-18 can optionally include wherein responsive to the user being authenticated with the primary fleet tool services using an access token, authenticating the user with the backup tool using the access token, wherein the authenticating further comprises authorizing the user, and wherein the backup tool is served as a subdomain of the primary fleet tool services to enable the authenticating and the authorizing the user with the backup tool using the access token. In Example 20, the subject matter of Examples 16-19 can optionally include wherein the one or more control commands comprise at least one of a stop command, a summon command, a circle command, and a release command.

Example 21 is a system for facilitating a backup system for observability, communication, and control of autonomous systems. The system of Example 21 can optionally include a memory to store a block of data, and one or more hardware processors to initialize an instance of a backup tool to provide observability, communication, and control of a fleet of autonomous vehicles (AVs) responsive to an outage of primary fleet tool services; store, by the instance of the backup tool, AV data received from the fleet of AVs in in-memory storage of the instance of the backup tool; populate, by the backup tool, a cache of the backup tool with semi-static data corresponding to the fleet of AVs; authenticate, by the instance of the backup tool, a user requesting access to the instance, the authenticating to utilize credentials of the user established with the primary fleet tool services; and facilitate, by the instance responsive to a request of the user, issuance of one or more control commands to the fleet of AVs based on the AV data stored in the in-memory storage and based on the semi-static data stored in the cache.

In Example 22, the subject matter of Example 21 can optionally include wherein the AV data is received via messages published by the AV and consumed by the backup tool on an intermittent basis. In Example 23, the subject matter of Examples 21-22 can optionally include wherein the semi-static data comprises fleet data corresponding to the fleet of AVs, wherein the fleet data comprises one or more of a list of fleets in a market of the fleet of AVs, a list of fleet facilities in the market of the fleet of AVs, physical locations of the fleet facilities, or vehicle identification numbers (VINs) of AVs of each of the fleets in the market.

In Example 24, the subject matter of Examples 21-23 can optionally include wherein responsive to the user being authenticated with the primary fleet tool services using an access token, authenticating the user with the backup tool using the access token, wherein the authenticating further comprises authorizing the user, and wherein the backup tool is served as a subdomain of the primary fleet tool services to enable the authenticating and the authorizing the user with the backup tool using the access token. In Example 25, the subject matter of Examples 21-24 can optionally include wherein the one or more control commands comprise at least one of a stop command, a summon command, a circle command, and a release command. In Example 26, the subject matter of Examples 21-25 can optionally include wherein causing the one or more control commands to be issued further comprises directly interfacing with a dispatch controller of at least one of the AVs, wherein a dispatcher is signaled to transition control of the fleet of AVs to the instance of the backup tool.

Example 27 includes an apparatus comprising means for performing the method of any of the Examples 1-9. Example 28 is at least one machine readable medium comprising a plurality of instructions that in response to being executed on a computing device, cause the computing device to carry out a method according to any one of Examples 1-9. Example 29 is an apparatus for facilitating a backup system for observability, communication, and control of autonomous systems, configured to perform the method of any one of Examples 1-9. Specifics in the Examples may be used anywhere in one or more embodiments.

The various embodiments described above are provided by way of illustration and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A method comprising:
initializing, by a processing device, an instance of a backup tool to provide observability, communication, and control of a fleet of autonomous vehicles (AVs) responsive to an outage of primary fleet tool services;
storing, by the instance of the backup tool, AV data received from the fleet of AVs in in-memory storage of the instance of the backup tool;
populating, by the backup tool, a cache of the backup tool with semi-static data corresponding to the fleet of AVs;
authenticating, by the instance of the backup tool, a user requesting access to the instance, the authenticating to utilize credentials of the user established with the primary fleet tool services; and
facilitating, by the instance responsive to a request of the user, issuance of one or more control commands to the fleet of AVs based on the AV data stored in the in-memory storage and based on the semi-static data stored in the cache.

2. The method of claim 1, wherein the AV data is received via messages published by the AV and consumed by the backup tool on an intermittent basis.

3. The method of claim 1, wherein the semi-static data comprises fleet data corresponding to the fleet of AVs, wherein the fleet data comprises one or more of a list of fleets in a market of the fleet of AVs, a list of fleet facilities in the market of the fleet of AVs, physical locations of the fleet facilities, or vehicle identification numbers (VINs) of AVs of each of the fleets in the market.

4. The method of claim 1, wherein responsive to the user being authenticated with the primary fleet tool services using an access token, authenticating the user with the backup tool using the access token.

5. The method of claim 4, wherein the authenticating further comprises authorizing the user, and wherein the backup tool is served as a subdomain of the primary fleet tool services to enable the authenticating and the authorizing the user with the backup tool using the access token.

6. The method of claim 4, wherein the access token is proactively refreshed when a time to live (TTL) of the access token falls below a threshold value.

7. The method of claim 1, wherein the one or more control commands comprise at least one of a stop command, a summon command, a circle command, and a release command.

8. The method of claim 1, wherein causing the one or more control commands to be issued further comprises directly interfacing with a dispatch controller of at least one of the AVs.

9. The method of claim 8, wherein a dispatcher is signaled to transition control of the fleet of AVs to the instance of the backup tool.

10. An apparatus comprising:
one or more hardware processors to:
initialize an instance of a backup tool to provide observability, communication, and control of a fleet of autonomous vehicles (AVs) responsive to an outage of primary fleet tool services;
store, by the instance of the backup tool, AV data received from the fleet of AVs in in-memory storage of the instance of the backup tool;
populate, by the backup tool, a cache of the backup tool with semi-static data corresponding to the fleet of AVs;
authenticate, by the instance of the backup tool, a user requesting access to the instance, the authenticating to utilize credentials of the user established with the primary fleet tool services; and
facilitate, by the instance responsive to a request of the user, issuance of one or more control commands to the fleet of AVs based on the AV data stored in the in-memory storage and based on the semi-static data stored in the cache.

11. The apparatus of claim 10, wherein the AV data is received via messages published by the AV and consumed by the backup tool on an intermittent basis.

12. The apparatus of claim 10, wherein the semi-static data comprises fleet data corresponding to the fleet of AVs, wherein the fleet data comprises one or more of a list of fleets in a market of the fleet of AVs, a list of fleet facilities in the market of the fleet of AVs, physical locations of the fleet facilities, or vehicle identification numbers (VINs) of AVs of each of the fleets in the market.

13. The apparatus of claim 10, wherein responsive to the user being authenticated with the primary fleet tool services using an access token, authenticating the user with the backup tool using the access token, wherein the authenticating further comprises authorizing the user, and wherein the backup tool is served as a subdomain of the primary fleet tool services to enable the authenticating and the authorizing the user with the backup tool using the access token.

14. The apparatus of claim 10, wherein the one or more control commands comprise at least one of a stop command, a summon command, a circle command, and a release command.

15. The apparatus of claim 10, wherein causing the one or more control commands to be issued further comprises directly interfacing with a dispatch controller of at least one of the AVs, wherein a dispatcher is signaled to transition control of the fleet of AVs to the instance of the backup tool.

16. A non-transitory computer-readable medium having stored thereon instructions that, when executed by one or more processors, cause the one or more processors to:
initialize an instance of a backup tool to provide observability, communication, and control of a fleet of autonomous vehicles (AVs) responsive to an outage of primary fleet tool services;
store, by the instance of the backup tool, AV data received from the fleet of AVs in in-memory storage of the instance of the backup tool;
populate, by the backup tool, a cache of the backup tool with semi-static data corresponding to the fleet of AVs;
authenticate, by the instance of the backup tool, a user requesting access to the instance, the authenticating to utilize credentials of the user established with the primary fleet tool services; and
facilitate, by the instance responsive to a request of the user, issuance of one or more control commands to the fleet of AVs based on the AV data stored in the in-memory storage and based on the semi-static data stored in the cache.

17. The non-transitory computer-readable medium of claim 16, wherein the AV data is received via messages published by the AV and consumed by the backup tool on an intermittent basis.

18. The non-transitory computer-readable medium of claim 16, wherein the semi-static data comprises fleet data corresponding to the fleet of AVs, wherein the fleet data comprises one or more of a list of fleets in a market of the fleet of AVs, a list of fleet facilities in the market of the fleet of AVs, physical locations of the fleet facilities, or vehicle identification numbers (VINs) of AVs of each of the fleets in the market.

19. The non-transitory computer-readable medium of claim 16, wherein responsive to the user being authenticated with the primary fleet tool services using an access token, authenticating the user with the backup tool using the access token, wherein the authenticating further comprises authorizing the user, and wherein the backup tool is served as a subdomain of the primary fleet tool services to enable the authenticating and the authorizing the user with the backup tool using the access token.

20. The non-transitory computer-readable medium of claim 16, wherein the one or more control commands comprise at least one of a stop command, a summon command, a circle command, and a release command.
